(19) United States
(12) Patent Application Publication
(10) Pub. No.: US 2016/0197824 A1
(43) Pub. Date: Jul. 7, 2016

(54) PACKET FORWARDING

(71) Applicant: HANGZHOU H3C TECHNOLOGIES CO., LTD., Hangzhou, Zhejiang (CN)

(72) Inventors: Tao LIN, Beijing (CN); Weichun REN, Beijing (CN); Lianlei ZHANG, Beijing (CN); Shaobo WU, Beijing (CN); Xianghui ZHANG, Beijing (CN)

(73) Assignee: Hangzhou H3C Technologies Co., Ltd., Hangzhou (CN)

(21) Appl. No.: 14/899,925

(22) PCT Filed: Sep. 24, 2014
(86) PCT No.: PCT/CN2014/087263

§ 371 Date: Dec. 18, 2015

(30) Foreign Application Priority Data
Sep. 25, 2013 (CN) 201310470421.6

(51) Int. Cl. H04L 12/721

(52) U.S. Cl. CPC H04L 45/38

(57) ABSTRACT

A controller of a virtual switch system receives an uplink packet forwarded by a SDN switch hosted on a server from a VM (virtual machine) hosted on the server. The controller determines an outgoing interface from at least two uplink interfaces on the SDN switch respectively corresponding to aggregated member ports of a physical switch by using an aggregation algorithm according to the uplink packet. The controller generates a first flow table entry and sends the first flow table entry to the SDN switch, wherein the first flow table entry is to instruct the SDN switch to forward a received uplink packet to the physical switch through the outgoing interface.

### BACKGROUND

Virtualization technology abstracts a physical resource and/or service, so that a resource consumer and a system administrator can use or manage the resource without considering the underlying physical resource in detail. This may reduce resource usage and management complexity and improve efficiency of use. The virtualization technology of a data center may include any of: network virtualization, storage virtualization and server virtualization. Multiple virtual machines (VMs) can be set up on a physical server and managed through virtualization software.

Software defined networking (SDN) is a technology in which the data plane and control plane of a network switch are separated into different devices. The SDN switch has a data plane comprising a flow table with entries defining how the switch is to handle received packets which match a particular flow. A SDN controller communicates with the SDN switch over a control channel using as SDN protocol. The SDN controller may populate or modify certain entries of a flow table on the SDN switch. One example of a SDN protocol is the Openflow (OF) protocol. Controllers and switches using the OF protocol may be referred to as OF controllers and OF switches respectively.

### BRIEF DESCRIPTION OF DRAWINGS

Features of the present disclosure are illustrated by way of example and not limited in the following figures, in which similar numerals indicate similar elements.

FIG. 1 is an example of an architecture diagram of a distributed virtual switch system according to the present disclosure.

FIG. 2 is an example of a schematic diagram of an interface of a SDN switch according to the present disclosure.

FIG. 3 is an example of a schematic flowchart of a method for packet forwarding according to the present disclosure.

FIG. 4 is another example of a schematic flowchart of a method for packet forwarding according to the present disclosure.

FIG. 5 is an example of a schematic flowchart of a method for creating an aggregation group corresponding to a SDN switch according to the present disclosure.

FIG. 6 is an example of a schematic flowchart of a method for deleting an interface in an aggregation group according to the present disclosure.

FIG. 7 is an example of a schematic flowchart of a method for flow modifying according to the present disclosure.

FIG. 8 is an example of a schematic flowchart of a method for forwarding a downlink unicast packet according to the present disclosure.

FIG. 9 is another example of a schematic flowchart of a method for forwarding a downlink multicast packet according to the present disclosure.

FIG. 10 is an example of a networking schematic diagram of a distributed virtual switch system according to the present disclosure.

FIG. 11 is an example of a structure diagram of a controller according to the present disclosure.

FIG. 12 is another example of an architecture diagram of a virtual switch system according to the present disclosure.

FIG. 13 is another example of a structure diagram of a controller according to the present disclosure.

### DETAILED DESCRIPTION

The following examples in the present disclosure provide a method for packet forwarding that may be applied to a distributed virtual switch system and a controller that may adopt the method.

A virtual switch is a switch which is hosted on a server and allows virtual machines to communicate with each other. A virtual switch may for instance be implemented by software running on a hardware processor of a server and may have virtual ports to connect with virtual machines running on the server and with an external communication interface of the server. A SDN virtual switch is a virtual switch which operates according to the principles of SDN and may for instance have a flow table which may be configured or populated by a SDN controller. A distributed virtual switch system is a system comprising a plurality of virtual switches distributed over a plurality of servers.

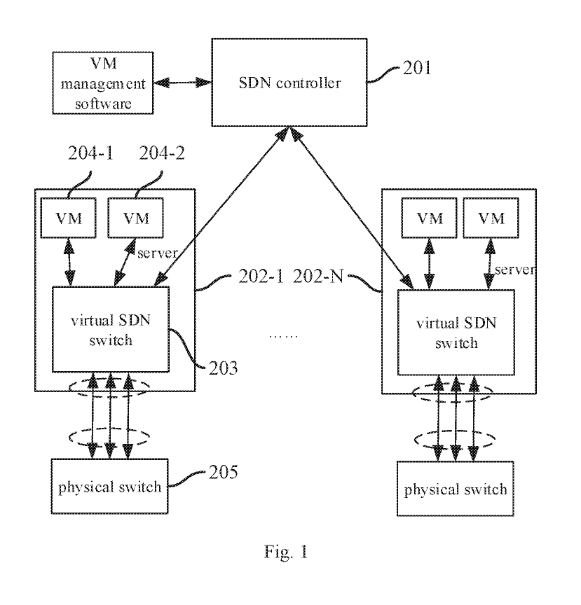

FIG. 1 shows an example of a distributed virtual switch system which includes a SDN controller 201 and multiple servers (N servers are a server 202-1 . . . a server 202-N respectively, wherein N is an integer and no less than 2). Take the server 202-1 as an example, in the FIG. 1, there is a virtual SDN (e.g. openflow) switch 203 and two VMs (VM 204-1 and VM 204-2 respectively) hosted on the server 202-1. The number of VMs hosted on the server 202-1 may be one or more than one and, and the number of VMs hosted on the other servers may be the same or different. The VMs are connected to an external physical switch 205 through the virtual SDN switch 203. The physical switch 205 may for example be a Top of the Rack (ToR) switch or an edge switch. The controller 201 may control all the virtual SDN switches together by utilizing a SDN protocol. A SDN switch is connected with a physical switch, and a physical switch may be connected with multiple SDN switches. There are at least two links (three links are shown in FIG. 1) between one SDN switch and its connected physical switch, which aggregate into one logical link by a link aggregation (LA) technology.

As shown in FIG. 2, on a SDN switch 301, there are two types of interfaces: one is an uplink interface (also called an uplink port), and the other is a downlink interface called a dvport interface (also called a dvport port). An uplink interface is an interface which is connected with a physical switch. E.g. uplink interface 302 is connected with a physical switch 304. A downlink interface (also called a dvport) is an interface which is connected with a virtual machine, e.g. via a virtual network card interface. For example dvport interface 303 is connected with a virtual network card interface 306 on VM 305.

A packet received by the SDN switch may be an uplink packet or a downlink packet. The uplink packet which is received by the SDN switch through any one dvport interface is sent by the VM, and the downlink packet is received by the SDN switch through any one uplink interface connected with the physical switch.

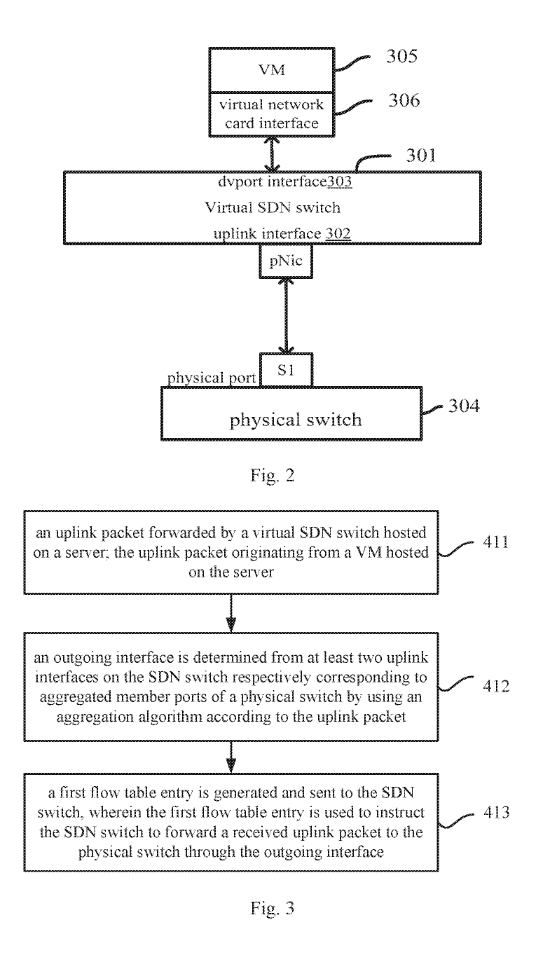

FIG. 3 is an example of a schematic flowchart of a method for packet forwarding according to the present disclosure. The method which may be applied to a virtual switch system such as the distributed virtual switch system of FIG. 1 is executed by the controller in the distributed virtual switch system such as the controller 201 of FIG. 1. The method includes following blocks.

At block 411, an uplink packet forwarded by a SDN switch hosted on a server of the virtual switch system; the uplink packet originating from a VM hosted on the server.

At block 412, an outgoing interface is determined from at least two uplink interfaces on the SDN switch respectively corresponding to aggregated member ports of a physical switch by using an aggregation algorithm according to the uplink packet.

At block 413, a first flow table entry is generated and sent to the SDN switch, wherein the first flow table entry is used to instruct the SDN switch to forward a received uplink packet to the physical switch through the outgoing interface.

The uplink packet of the SDN switch received by the controller may be an initial packet of a data flow.

Correspondingly, a process of the method on the SDN switch side may be as below:

An uplink packet received from a VM is sent to the controller.

A first flow table entry sent by the controller is received, wherein the first flow table entry is generated by the controller according to the uplink packet.

An outgoing interface is determined from at least two uplink interfaces on the SDN switch respectively corresponding to aggregated member ports of a physical switch according to the first flow table entry sent by the controller, and received uplink packet is forwarded to the physical switch through the outgoing interface.

The uplink packet that is used to generate the first flow table entry by the controller may be the initial packet of the data flow. Before sending the initial packet to the controller, the SDN switch may store the initial packet, or the SDN switch may not store the initial packet and wait for the initial packet sent by the controller together with the first flow table entry.

By adopting the method described above, when receiving a subsequent uplink packet which belongs to the same data flow as the initial uplink packet, the SDN switch determines the outgoing interface to forward the subsequent uplink packet according to the first flow table entry sent by the controller without computing the outgoing interface by utilizing the aggregation algorithm, thus improving packet forwarding efficiency.

To be more clearly and intuitively, further examples are given below to help understanding of various aspects of the present disclosure. Obviously, the method of the present disclosure is not limited to these details. Some examples have not been described in detail as not to unnecessarily obscure aspects of the present disclosure. Hereafter, “include” means “include, but not limited to”, and “according to . . . ” means “at least according to . . . , but not limited to just according to . . . ”. When the number of elements is not particularly pointed out blow, it means that the number of elements may be 1 or more, or it can be understood that there is at least one element.

In addition, although the terms first, second, etc. may be used herein to describe various elements, these elements should not be limited by these terms. For example, a first flow table entry and a second flow table entry are both flow table entries, but they are not the same flow table entry.

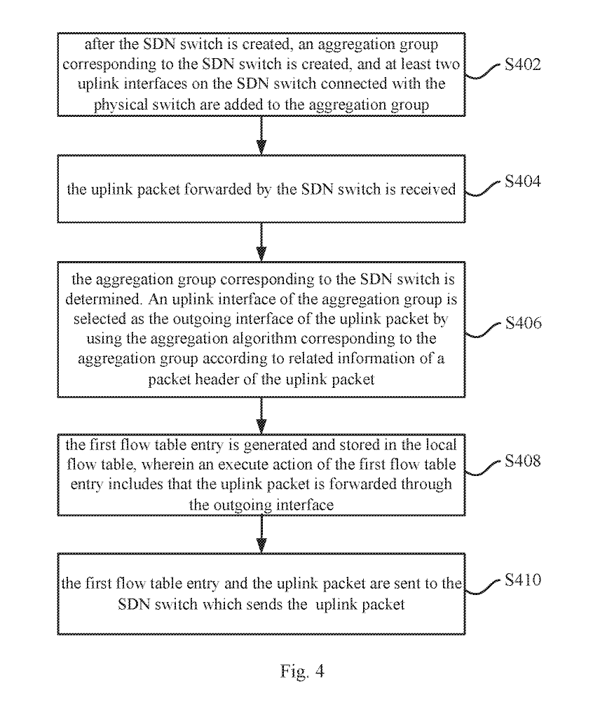

In the present disclosure, for example, a method for packet forwarding of the distributed virtual switch system is executed by the controller. As shown in FIG. 4, the method includes following blocks.

At block S402, after the SDN switch is created, an aggregation group corresponding to the SDN switch is created, and at least two uplink interfaces on the SDN switch connected with the physical switch are added to the aggregation group.

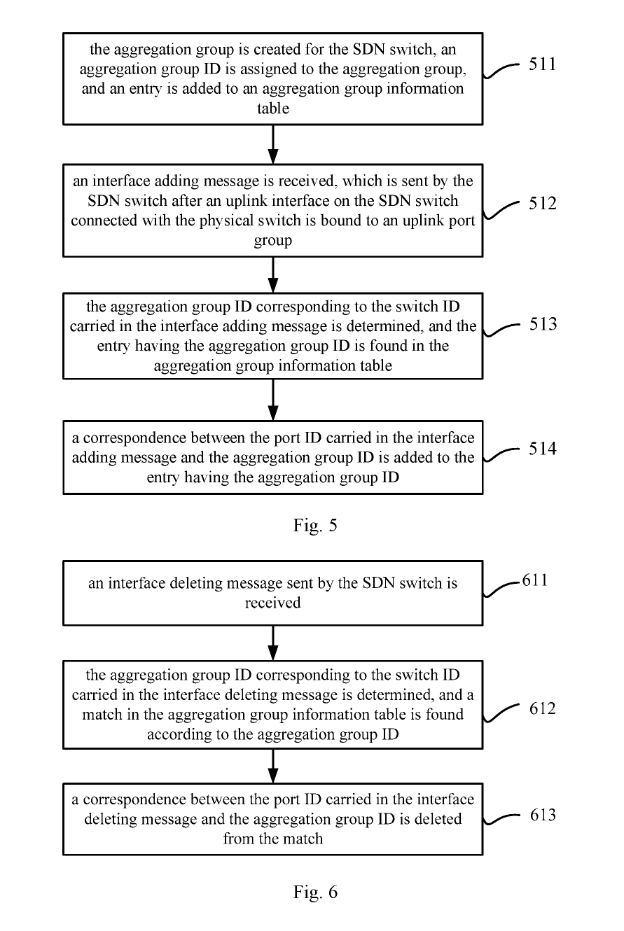

As shown in FIG. 5, the method in the block S402 may include following blocks:

At block 511, the aggregation group is created for the SDN switch, an aggregation group identity (ID) is assigned to the aggregation group, and an entry is added to an aggregation group information table, wherein the entry including the aggregation group ID and the aggregation algorithm corresponding to the aggregation group.

At block 512, an interface adding message is received, which is sent by the SDN switch after an uplink interface on the SDN switch connected with the physical switch is bound to an uplink port group, wherein the interface adding message carries a switch ID of the SDN switch and a port ID of the uplink interface.

At block 513, the aggregation group ID corresponding to the switch ID carried in the interface adding message is determined, and the entry having the aggregation group ID is found in the aggregation group information table.

At block 514, a correspondence between the port ID carried in the interface adding message and the aggregation group ID is added to the entry having the aggregation group ID.

Further, the method of creating the aggregation group corresponding to the SDN switch and adding the at least two uplink interface on the switch connected with the physical switch to the aggregation group includes two following aspects.

(1) A Process of Creating the SDN Switch

At block 11, after a virtual machine management (VMM) center performs an operation of adding a host (i.e. a server), the server is notified to create a SDN switch.

At block 12, after receiving the notice, the server creates a SDN switch in the server and assigns a switch identity (ID) to the SDN switch. The created SDN switch is thus hosted on the server.

At block 13, by adopting the OF protocol, a switch adding message carrying the switch ID of the SDN switch, is sent by the SDN switch.

At block 14, after receiving the switch adding message, the controller creates an aggregation group for the SDN switch, assigns an aggregation group ID to the aggregation group, and adds an entry including the aggregation group ID and the aggregation algorithm corresponding to the aggregation group to a local aggregation group information table.

At block 14, after creating the aggregation group for the SDN switch and assigning the aggregation group ID to the aggregation group, the controller may store a correspondence between the switch ID of the SDN switch and the aggregation group ID.

Assuming the aggregation group ID assigned to the aggregation group is 1 at block 14, the added entry may be shown as Table 1-1:

TABLE 1-1

| aggregation group ID | member port ID | aggregation algorithm |
|---|---|---|
| 1 | | aggregation algorithm to |
| | | be used |

In the Table 1-1, the aggregation group ID and member port IDs of the aggregation group and the aggregation algorithm corresponding to the aggregation group are recoded in the aggregation group information table. In an actual implementation process, more information, such as a port state of the member port and an aggregation mode of the aggregation group, may be recoded, as shown in Table 1-2.

TABLE 1-2

| aggregation | member port | port | aggregation | |
|---|---|---|---|---|
| group ID | ID | state | mode | aggregation algorithm |
| 1 | | | Static | aggregation algorithm |
| | | | | to be used |

When the Table 1-2 is taken as the aggregation group information table, at block 14, after receiving the switch adding message, the controller creates an aggregation group for the SDN switch, assigns an aggregation group ID to the aggregation group, and adds an entry to the aggregation group information table, wherein the entry includes the aggregation group ID, the aggregation algorithm corresponding to the aggregation group and the aggregation mode of the aggregation group. In the example of the present disclosure, the aggregation mode supports a static aggregation mode.

In the actual implementation process, in the beginning, the controller may add an entry including the aggregation group ID and the aggregation algorithm corresponding to the aggregation group in the aggregation group information table, and set the aggregation algorithm corresponding to the aggregation group as a predetermined default aggregation algorithm. Subsequently, under configuration of a user, a VMM Center may modify any one aggregation algorithm corresponding to the aggregation group into a new aggregation algorithm, and notify the controller of the aggregation group ID and the new aggregation algorithm corresponding to the aggregation group. After receiving the notice, the controller looks up a match in the aggregation group information table according to the aggregation group ID of the notice, and modifies the aggregation algorithm in the found match into the new aggregation algorithm.

In addition, the aggregation algorithm in the present disclosure, which can be based on such parameters as a source MAC, a destination MAC, a source IP address, and/or a destination IP address, may be the same as that in the prior art and will not be not described redundantly herein. All the member ports in the aggregation group of the example are uplink interfaces.

(2) A Process of Binding an Uplink Interface on the SDN Switch

At block 21, the VMM Center binds an uplink interface on the SDN switch to an uplink port group, and sends a notice of the event to the SDN switch, wherein a port ID of the uplink interface is included in the notice.

In the actual implementation process, there is one uplink port group in the distributed virtual switch system, and all the uplink interfaces of the SDN switch are bound to the uplink port group.

At block 22, after the SDN switch receives the event, the SDN switch sends an interface adding message to the controller, wherein the interface adding message carries the switch ID of the SDN switch and the port ID of the uplink interface.

At block 23, the controller receives the interface adding message carrying the switch ID of the SDN switch and the port ID of the uplink interface, which is sent by the SDN switch after an uplink interface on the SDN switch connected with the physical switch is bound to an uplink port group.

At block 24, the controller determines the aggregation group ID corresponding to the switch ID carried in the interface adding message, and finds the entry having the determined aggregation group ID in the aggregation group information table.

At block 25, the controller adds a correspondence between the port ID carried in the interface adding message and the determined aggregation group ID to the entry having the determined aggregation group ID.

Suppose the determined aggregation group ID is 1 and the port ID carried in the interface adding message is Port 1. After the block 25 is performed, the entry shown in Table 1-1 is updated, as shown in Table 2-1, and the entry shown in Table 1-2 is updated, as shown in Table 2-2.

TABLE 2-1

| aggregation group ID | member port ID | aggregation algorithm |
|---|---|---|
| 1 | Port1 | aggregation algorithm to |
| | | be used |

TABLE 2-2

| aggregation | member | port | aggregation | |
|---|---|---|---|---|
| group ID | port ID | state | mode | aggregation algorithm |
| 1 | Port1 | Selected | Static | aggregation algorithm |
| | | | | to be used |

In the actual implementation process, the member ports in the aggregation group have two states: a selected state and an unselected state. The member port in the selected state, called “a selected port”, may participate in the data forwarding; and the member port in the unselected state, called “an unselected port”, can not participate in the data forwarding. Therefore, when the Table 1-2 is taken as the aggregation group information table, at block 25, while adding a correspondence between the port ID carried in the interface adding message and the determined aggregation group ID into the entry having the determined aggregation group ID, the controller needs to set the port state corresponding to the port ID to the default state, that is, the selected state.

Subsequently, under the configuration of the user, the VMM Center may modify the state of any one of member ports of any aggregation group from the selected state into the unselected state or from the unselected state into the selected state, and send a notice of the port state modifying event to the controller, wherein the aggregation group ID of the aggregation group to which the member port belongs, and the port ID and the new modified port state of the member port are included in the notice. After receiving the notice, the controller finds a match in the aggregation group information table according to the aggregation group ID included in the notice, and modifies the port state of the corresponding port ID (the same as the port ID included in the notice) in the match into the new port state included in the notice.

At block S404, the uplink packet forwarded by the SDN switch is received, wherein the uplink packet is received by the SDN switch through a dvport interface connected with the VM.

After receiving a packet sent by the VM or ToR, the SDN switch will look up an entry in a local flow table according to information of a packet header of the packet. When it is not found, the packet is encapsulated as an OF message and sent to the controller; and when it is found, the packet is forwarded according to the found first flow table entry.

At block S404, the controller determines whether the packet is received by the SDN switch though the uplink interface or the dvport interface. In a determination method, on the basis of the switch ID carried in a message header of the OF message and a port identity of a source port, a corresponding type of a port group is found. When the found type of the port group is an uplink-interface type, it is determined that the received packet which is a downlink packet is received by the SDN switch through the uplink interface; and when the found type of the port group is a dvport-interface type, it is determined that the received packet which is an uplink packet is received by the SDN switch through the dvport interface. The source port is the port where the SDN switch receives the packet, that is, an ingress port where the packet enters into the SDN switch.

Each port group, port IDs of all interfaces of the port group, the type of the port group and a VLAN to which the port group belongs are stored in the controller, wherein the type of the port group is the uplink-interface type or the dvport-interface type. When the type of the port group is the uplink-interface type, the port group is called an uplink port group; and when the type of the port group is the dvport-interface type, the port group is called a downlink port group.

At block S406, the aggregation group corresponding to the SDN switch is determined. An uplink interface of the aggregation group is selected as the outgoing interface of the uplink packet by using the aggregation algorithm corresponding to the aggregation group according to related information of a packet header of the uplink packet, wherein the related information includes one or more of: a source MAC address, a destination MAC address, a source IP address and a destination IP address.

At block S408, the first flow table entry is generated and sent to the SDN switch, wherein the first flow table entry is used to instruct the SDN switch to forward a received uplink packet to the physical switch through the outgoing interface, namely, an execute action of the first flow table entry includes that the uplink packet is forwarded through the outgoing interface. Further, the controller stores the first flow table entry into a local flow table.

At block S404, the uplink packet received by the controller and sent by the SDN switch is encapsulated in the OF message carrying the switch ID of the SDN switch, so the controller may find the aggregation group ID corresponding to the switch ID according to the switch ID carried in the OF message at block S406, and then find the entry including the aggregation group ID in the aggregation group information table.

In the actual implementation process, after receiving the uplink packet sent by the SDN switch, the controller may look up a match in an interface management table according to a source MAC address in the uplink packet first. When the match is found, the blocks S406-S408 are executed; and when the match is not found, some information in the uplink packet may be recorded in a dynamic table. Interface information corresponding to the VM is recorded in the interface management table, which includes the switch ID of the SDN switch connected with the VM, a MAC address of a virtual network card interface on the VM connected with the SDN switch, a VLAN ID of the VLAN to which a dvport interface belongs and a port ID of the dvport interface on the SDN switch connected with the VM, etc.

At block S406, an uplink interface in the aggregation group is selected as the outgoing interface for the uplink packet by using the aggregation algorithm corresponding to the aggregation group according to related information of a packet header of the uplink packet. As an example, a Hash algorithm is performed on one or more of a source MAC address, a destination MAC address, a source IP address and a destination IP address, to obtain a hash value recoded as KEY. A modulus operation is performed upon the hash value KEY and N (that is, KEY % N, and % is the modulus operator) to obtain a modulus result (recoded as M, and M=0, 1, . . . , (N−1)), wherein N the total number of uplink interfaces participating in the aggregation algorithm in the aggregation group. It is determined that which uplink interface is selected as the outgoing interface of the uplink packet according to the value M, namely, a relative position of the selected uplink interface is determined by the value M. For example, when M=0, the first uplink interface participating in the aggregation algorithm in the aggregation group is selected, and when M=1, the second uplink interface participating in the aggregation algorithm in the aggregation group is selected, and so on.

The port state of the uplink interfaces participating in the aggregation algorithm in the aggregation group is the selected state, and the uplink interface in the unselected state does not participate in the aggregation algorithm.

In addition, in the actual implementation of the blocks S406-S408, the corresponding VLAN ID may be found according to the switch ID and the source port ID carried in the message header of the OF message including the uplink packet. The execute action of the first flow table entry may also include that the found VLAN ID is added in the uplink packet.

At block S410, the first flow table entry and the uplink packet are sent to the SDN switch which sends the uplink packet.

After receiving the uplink packet and the first flow table entry sent by the controller, the SDN switch adds the first flow table entry into the local flow table, then finds a match in the local flow table according to the information of the packet header of the uplink packet, and forwards the uplink packet to the physical switch in accordance with the execute action in the match.

The uplink packet at the above blocks S404-S410 may be a unicast packet or a multicast packet.

By adopting the above method of the present disclosure, after the SDN switch is created, the controller will create the corresponding aggregation group corresponding to the SDN switch, and add multiple uplink interfaces on the SDN switch connected with the physical switch into the aggregation group. In such a case, after receiving the uplink packet that is sent by the SDN switch through a dvport interface, the controller may select an uplink interface of the aggregation group as the outgoing interface of the uplink packet by using the aggregation algorithm corresponding to the aggregation group according to related information of the packet header of the uplink packet, and then generate the first flow table entry guiding the forwarding of the uplink packet according to the outgoing interface. The packet forwarding supporting a function of the link aggregation is implemented by the above method in the distributed virtual switch system based on the openflow. After the controller computes the outgoing interface for a first packet of a data flow by adopting the aggregation algorithm, generates the first flow table entry and sends it to the SDN switch, no aggregation algorithm is required to compute the outgoing interface for a subsequent packet of the data flow, thus improving the packet forwarding efficiency.

In addition, there is an issue that the member port of the aggregation group is changed and the controller has generated the flow table entry related to the member port of the aggregation group. When the member port of the aggregation group is changed, it is likely to lead to a change in the aggregation algorithm corresponding to the aggregation group. For example, when the number of the member ports in the aggregation group increases, the total number of the member ports participating in the aggregation algorithm in the aggregation group will also increase, which leads to the change in the aggregation algorithm corresponding to the aggregation group. In such a case, the flow table entry related to the member port of the aggregation group that has been generated by the controller will become invalid, it is necessary to correspondingly delete the flow table entry. Two situations of increasing and decreasing the member ports are introduced below respectively.

(1). Increase of the Member Ports in the Aggregation Group

Blocks 31-35 are the same as blocks 21-25, which will not be described redundantly herein.

For ease of description, here the aggregation group is called an original aggregation group before a new member port is added to the aggregation group, and the member ports in the original aggregation group is called original member ports; and the aggregation group is called a new aggregation group after a new member port is added to the aggregation group, and a newly added member port in the new aggregation group is called a new member port. After the new member port is added, the existing flow table entry that is generated for the original group will not be processed.

The flow table entry occurs with aging, so the existing flow table entry that is generated for the original group is deleted due to aging. Later, the SDN switch receives an uplink packet and looks up the match in the local flow table, and when the match is not found, the uplink packet will be sent to the controller. A business type of the uplink packet may be the same as that of the previously received data flow, or may be a new business type of a data flow that has not been received before. As for the uplink packet having the same business type as the previously received data flow, because the previously generated flow table entry has been deleted due to aging, the match will no be found; and as for the uplink packet having the new business type with which the data flow has not been received before, because the flow table entry is not generated, the match will not be found.

After receiving the uplink packet, the controller will generate the first flow table entry used for guiding the forwarding of the uplink packet as described is the blocks S406-S410. The outgoing interface is computed by using an aggregation algorithm of the new aggregation group. For example, in KEY % N, N is the total number of the original member ports and the new member ports.

An aging mechanism of the flow table entry may adopt in the following two ways. In the first way, an aging timer is set, and when the aging timer expires, the corresponding flow table entry occurs with aging; and in the second way, aging time is set, and when the flow table entry is not used during the aging time, the flow table entry occurs with aging.

(2). Decrease of the Member Ports in the Aggregation Group

After the aggregation group corresponding to the SDN switch is created, the interface in the aggregation group may be deleted. As shown in FIG. 6, the method is executed by the controller, may include the following blocks.

At block 611, an interface deleting message sent by the SDN switch is received, wherein the interface deleting message is sent by the SDN switch after the SDN switch removes its uplink interface from binding of the uplink port group or detects that its uplink interface become unavailable, and the interface deleting message carries the switch ID of the SDN switch and the port ID of the uplink interface.

At block 612, the aggregation group ID corresponding to the switch ID carried in the interface deleting message is determined, and a match in the aggregation group information table is found according to the aggregation group ID.

At block 613, a correspondence between the port ID carried in the interface deleting message and the aggregation group ID is deleted from the match.

Further, the controller may perform flow modifying after the block 611. As shown in FIG. 7, the following blocks are included.

At block 711, after the interface deleting message is received, a match is looked up in the local flow table according to the switch ID and the port ID carried in the interface deleting message.

At block 712, when the match is found, the found match is deleted, and a flow-modifying message is sent to the SDN switch that is indicated by the switch ID carried in the interface deleting message. The flow-modifying message carrying the switch ID and the port ID is used to instruct the corresponding SDN switch to look up a match in the local flow table according to the switch ID and the port ID and delete the found match.

As a specific example, the following blocks are included.

At block 41, the VMM Center removes the uplink interface on the SDN switch from binding of the uplink port group, and sends a notice of the removing event to the SDN switch, wherein the port ID of the uplink interface is included in the notice; or the ToR shutdown a physical interface connected with the SDN switch.

At block 42, after receiving the removing event or detecting that an uplink interface connected with the ToR become unavailable, the SDN switch sends the interface deleting message carrying the switch ID of the SDN switch and the port ID of the uplink interface to the controller.

At block 43, the controller receives the interface deleting message sent by the controller, wherein the interface deleting message carries the switch ID of the SDN switch and the port ID of the uplink interface to the controller.

At block 44, the controller determines the aggregation group ID corresponding to the switch ID carried in the interface deleting message, looks up a match in the aggregation group information table according to the determined aggregation group ID, and deletes the correspondence between the port ID carried in the interface and the determined aggregation group ID from the found match.

Suppose the match found at block 44 is shown as Table 3-1 and the port ID carried in the interface deleting message is Port1. After the block 44 is performed, the entry shown in Table 3-1 is updated, as shown in Table 3-2.

TABLE 3-1

| aggregation | member port | | aggregation | aggregation |
|---|---|---|---|---|
| group ID | ID | port state | mode | algorithm |
| 1 | Port1 | Selected | Static | aggregation |
| | Port2 | Selected | | algorithm to be |
| | Port3 | Selected | | used |

TABLE 3-2

| aggregation | | | aggregation | aggregation |
|---|---|---|---|---|
| group ID | member port ID | port state | mode | algorithm |
| 1 | Port2 | Selected | Static | aggregation |
| | | | | algorithm to |
| | | | | be used |

At block 45, the controller looks up the match in the local flow table according to the port ID carried in the deleting message. When the match is found, the block 46 is performed, otherwise the process is terminated.

At block 46, the controller deletes the found match, and sends a flow-modifying message to the SDN switch that is indicated by the switch ID carried in the interface deleting message, wherein the flow-modifying message carrying the switch ID and the port ID is used to instruct the corresponding SDN switch to look up a match in the local flow table according to the port ID and delete the found match.

After receiving the interface deleting message sent by the controller, the SDN switch looks up a match in the local flow table according to the port ID carried in the interface deleting message, and deletes the found match.

Subsequently, when the SDN switch receives the uplink packet and looks up the match according the information of the packet header of the uplink packet, the match is not found, and then the SDN switch sends the uplink packet to the controller. The controller generates the first flow table entry guiding the forwarding of the uplink packet again according to the block S406 mentioned above, which will not be repeated herein.

In addition, the downlink packet received by the SDN switch may be a packet sent by the physical switch (ToR) of which a forwarding path is from the VM to the SDN switch to the ToR to the SDN switch, or may be a packet of which a forwarding path is from an external device (other device connected with the ToR which does not belong to the distributed virtual switch system) to the ToR to the SDN switch. A processing flow of the downlink packet is as below: after receiving the packet and before forwarding the packet to the SDN switch, the ToR selects a physical port as an outgoing interface from physical ports corresponding to the aggregation group according to an aggregation algorithm on the ToR corresponding to the aggregation group (that is, the aggregation algorithm corresponding the aggregation group which the physical ports of the ToR connected to the SDN switch belong to), and sends the packet to the SDN switch through the outgoing interface. Although there is a one-to-one correspondence between the physical port in the aggregation group of the ToR and the uplink interface in the same aggregation group of the SDN switch, the aggregation algorithm corresponding to the aggregation group of the ToR is independent of that corresponding to the aggregation group of the SDN switch. After receiving the downlink packet through an uplink interface connected with the ToR, the SDN switch determines whether the uplink interface for receiving the downlink packet is a valid port of the aggregation group which is available (UP) and in the selected state. When it is the valid port, the SDN switch looks up the match in the local flow table, and when the match is not found, the downlink packet is sent to the controller; and when it is not the valid port, the downlink packet is discarded. After receiving the downlink packet, the controller will generate a flow table entry guiding the forwarding of the downlink packet in a different process according to whether the downlink packet is the unicast packet or the multicast packet, store it in the local flow table, and send the downlink packet and the generated flow table entry to the SDN switch that sends the downlink packet.

In the link aggregation technology, the states of the ports of both ends of the same link (that is, a port in the aggregation group of one device and a corresponding port in the corresponding aggregation group of the other device at the opposite end) need to be consistent. Therefore, when there is an invalid uplink interface in the aggregation group of the SDN switch such as in the UP and unselected state or in DOWN (unavailable) and selected state, which shows that the state of the uplink interface is inconsistent with that of the corresponding physical port on the ToR, after the uplink packet sent by the ToR is received, such packet is not processed
(1) A Downlink Unicast Packet

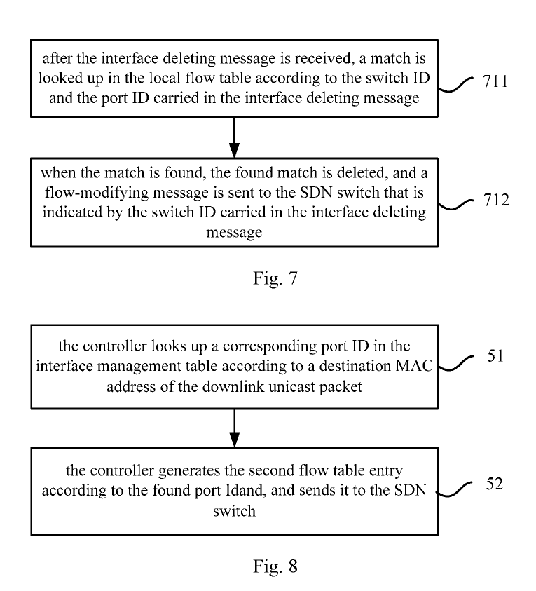

An example of a method for forwarding the downlink unicast packet, as shown in FIG. 8, may include the following blocks.

At block 51, the controller looks up a corresponding port ID in the interface management table according to a destination MAC address (or a destination MAC address and a VLAN ID) of the downlink unicast packet.

At block 52, the controller generates the second flow table entry according to the found port ID at block 51, and sends it to the SDN switch, wherein the second flow table entry is used to instruct the SDN switch to forward a received downlink unicast packet through a downlink interface indicated by the found port ID (that is, an execute action of the second flow table entry includes that the downlink unicast packet is forwarded through the dvport interface indicated by the found port ID). Further, the controller may store the second flow table entry into the local flow table.

In the actual implementation process, the execute action of the generated second flow table entry may also include that the VLAN ID in the downlink unicast packet is deleted.

(2) A Downlink Multicast Packet

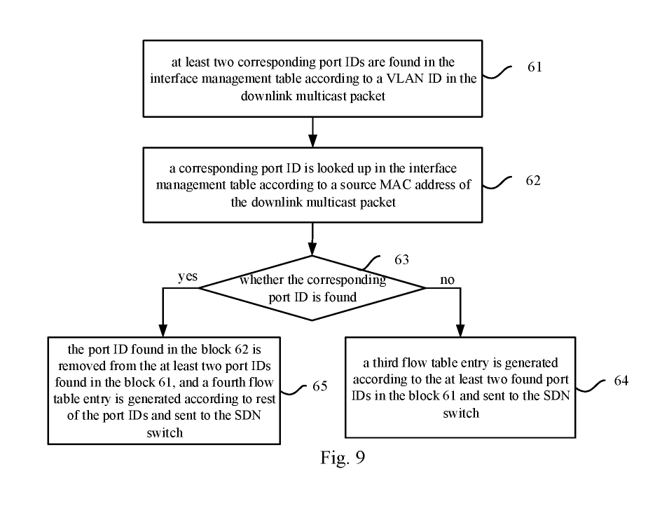

An example of a method for forwarding the downlink multicast packet which is executed by the controller, as shown in FIG. 9, may include the following blocks.

At block 61, at least two corresponding port IDs are found in the interface management table according to a VLAN ID in the downlink multicast packet, and block 62 is executed.

At block 62, a corresponding port ID is looked up in the interface management table according to a source MAC address (or a source MAC address and a VLAN ID) of the downlink multicast packet, and block 63 is executed.

At block 63, it is determined that whether the corresponding port ID is found at block 62. When it is not found, block 64 is executed, otherwise block 65 is executed.

At block 64, a third flow table entry is generated according to the at least two found port IDs at block 61 and sent to the SDN switch, wherein the third flow table entry is used to instruct the SDN switch to forward a received downlink multicast packet through downlink interfaces indicated by the at least two port IDs (that is, an execute action of the third flow table entry includes that the downlink multicast packet is forwarded through the dvport interfaces indicated by the at least two port IDs). Further, the controller stores the third flow table entry into the local flow table.

In the actual implementation process, the execute action of the generated third flow table entry may also include that the VLAN ID in the downlink multicast packet is deleted.

At block 65, the port ID found at block 62 is removed from the at least two port IDs found at block 61, and a fourth flow table entry is generated according to rest of the port IDs and sent to the SDN switch, wherein the fourth flow table entry is used to instruct the SDN switch to forward a received downlink multicast packet through downlink interface(s) indicated by the rest of the port IDs (that is, an execute action of the fourth flow table entry includes that the downlink multicast packet is forwarded through the dvport interface(s) indicated by the rest of the port IDs). Further, the controller stores the generated fourth flow table entry into the local flow table.

In the actual implementation process, the execute action of the generated fourth flow table entry may also include that the VLAN ID in the downlink multicast packet is deleted.

From the aforementioned processes of generating flow table entries regarding the downlink unicast packet and the downlink multicast packet, the outgoing interface is determined for the downlink multicast packet without using the aggregation algorithm.

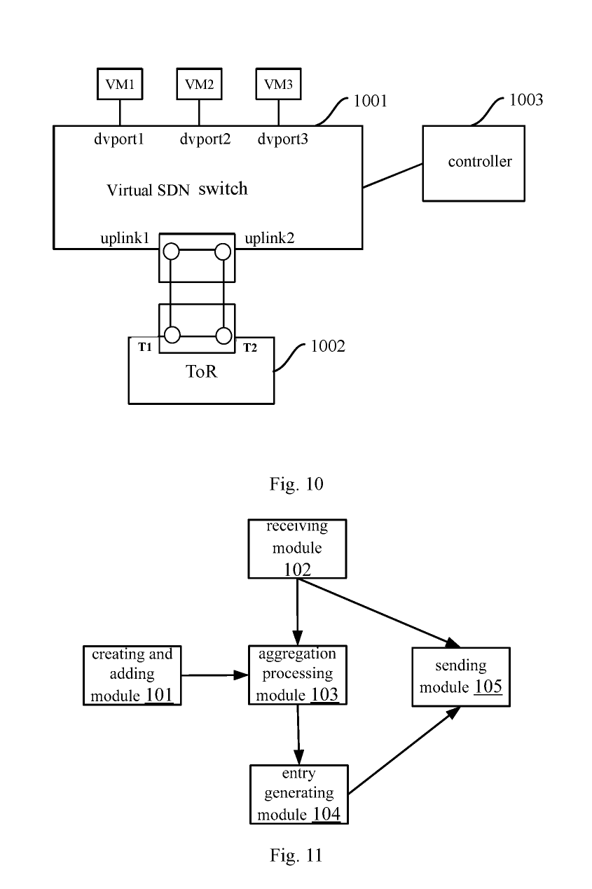

The method in the aforementioned examples will be described in detail by taking a distributed virtual switch system shown in FIG. 10 as an example. In the FIG. 10, a SDN switch 1001 connects virtual machines VM1-VM3 through dvport interfaces dvport1-dvport3 respectively, wherein MAC addresses of the dvport1-dvport3 are MAC1-MAC3 respectively, and these three dvport interfaces belong to VLAN1. There are two links between the SDN switch 1001 and its connected physical switch ToR 1002, which are aggregated by the link aggregation technology. That is, two uplink interfaces uplink1 and uplink2 on the SDN switch 100 connected with the ToR 1002 are added into a same aggregation group; and two physical ports T1 and T2 on the ToR 1002 connected with the SDN switch 100 are added into a same aggregation group.

The controller 1003 adds an entry into the aggregation group information table shown in Table 4-1 according to the above block S402.

TABLE 4-1

| aggregation | member | | aggregation | |
|---|---|---|---|---|
| group ID | port ID | port state | mode | aggregation algorithm |
| 2 | uplink1 | Selected | Static | aggregation algorithm |
| | uplink2 | Selected | | according to a source |
| | | | | MAC address |

The SDN switch 1001 receives an uplink packet send by the VM2 through the dvport2. A source MAC address of the uplink packet is MAC2 and a VLAN ID is a VLAN1. The SDN switch looks up a match in a local flow table according to related information of a packet header of the uplink packet, but the match is not found. The SDN switch 1001 encapsulates the uplink packet as an OF message and sends the OF message to a controller 1003, wherein a message header of the OF message carries a switch ID of the SDN switch 1001 and an ingress port dvport2 of the uplink packet.

After receiving the OF message, the controller 1003 obtains the uplink packet through decapsulation, finds a downlink port group to which the ingress port belongs according to the switch ID and the ingress port dvport2 carried in the message header of the OF message, and determines that the corresponding VLAN ID is VLAN1. The controller determines that a aggregation group ID corresponding to the switch ID is 2, and then finds an entry including the aggregation group ID 2 in the aggregation group information table shown in Tale 4-1. According to the source MAC address MAC2, a member port is selected as an outgoing interface of the uplink packet from member ports in the entry by using an aggregation algorithm of the entry shown in the Table 4-1. Suppose the outgoing interface is uplink2, and the controller 1003 generates a first flow table entry guiding forwarding of the uplink packet as shown in Table 4-2, and stores it into a local flow table. The controller 1003 sends the uplink packet and the first flow table entry to the SDN switch 1001.

After receiving the uplink packet and the first flow table entry, the SDN switch 1001 stores the first flow table entry into the local flow table, and then finds the first flow table entry in the local flow table according to information such as a destination MAC address and the ingress port dvport2 in a packet header of the packet. The SDN switch 1001 adds a VLAN1 into the packet according to an execute action of the first flow table entry, and then forwards the packet to the ToR through the uplink2.

TABLE 4-2

| Header Fields | | | |
|---|---|---|---|
| Ether Dst (destination | | | Action |
| MAC) | Ingress Port | Counter | Forward |
| Destination MAC | dvport2 | | mod_vlan_vid: VLAN1 |
| address of the packet | | | Output to uplink2 |

Form the Table 4-2, the execute action in the generated first flow table entry includes that the uplink packet is forwarded through the uplink2 (that is, Output to uplink2), and the found VLAN ID VLAN1 (that is mod_vlan_vid: VLAN1) is added to the packet.

As an example, for the method in the example above, a controller of the distributed virtual switch system is provided by the present disclosure. As shown in FIG. 11, the controller includes following modules: a creating and adding module 101, a receiving module 102, an aggregation processing module 103, an entry generating module 104 and a sending module 105.

The creating and adding module 101 is to create an aggregation group corresponding to a SDN switch after the SDN switch is created, and to add the at least two uplink interfaces respectively corresponding to the aggregated member ports to the aggregation group.

The receiving module 102 is to receive an uplink packet sent by the SDN switch, wherein the uplink packet is received by the SDN switch through a dvport interface connected with a VM.

The aggregation processing module 103 is to determine the aggregation group corresponding to the SDN switch after the receiving module 102 receives the uplink packet sent by the SDN switch, and to select an uplink interface as an outgoing interface from the aggregation group by using an aggregation algorithm corresponding to the aggregation group according to related information of a packet header of the uplink packet, wherein the related information includes one or more of: a source MAC address, a destination MAC address, a source IP address and a destination IP address.

The entry generating module 104 is to generate a first flow table entry guiding forwarding of the uplink packet which is received by the receiving module 102, and to store it in the local flow table, wherein an execute action of the first flow table entry includes that the uplink packet is forwarded though the outgoing interface selected by the aggregation processing module 103.

The sending module 105 is to send the first flow table entry generated by the entry generating module 104 and the uplink packet received by the receiving module 102 to the SDN switch which sends the uplink packet.

The creating and adding module 101 includes a creating unit, an assigning unit, a message receiving unit, a determining and finding unit and an adding unit.

The creating unit is to create an aggregation group for the SDN switch.

The assigning unit is to assign an aggregation group ID for the aggregation group created by the creating unit.

The message receiving unit is to receive an interface adding message which is sent by the SDN switch after an uplink interface on the SDN switch connected with the physical switch is bound to an uplink port group, wherein the received interface adding message carries a switch ID of the SDN switch and a port ID of the uplink interface.

The determining and finding unit is to determine the aggregation group ID corresponding to the switch ID carried in the interface adding message which is received by the message receiving unit, and to find the entry having the aggregation group ID in the aggregation group information table.

The adding unit is to add an entry including the aggregation group ID and an aggregation algorithm corresponding to the aggregation group to the aggregation group information table after the assigning unit assigns the aggregation group ID for the aggregation group created by the creating unit. The adding unit is further to add a correspondence between the port ID carried in the interface adding message received by the message receiving unit and the aggregation group ID determined by the determining and finding unit to the entry having the determined aggregation group ID.

The local flow table in the controller may be stored in the entry generating module, and the aggregation group information table may be stored in the creating and adding module.

The controller may also include a determining module, a finding module and a deleting module.

The receiving module 102 is further to receive an interface deleting message sent by the SDN switch, wherein the interface deleting message carrying the switch ID of the SDN switch and the port ID of the uplink interface is sent by the SDN switch after the SDN switch removes its uplink interface from binding of the uplink port group or detects that its uplink interface become unavailable.

The determining module is to determine the aggregation group ID corresponding to the switch ID carried in the interface deleting message received by the receiving module 102.

The finding module is further to find a match in the aggregation group information table according to the determined aggregation group ID determined by the determining module.

The deleting module is further to delete a correspondence between the port ID carried in the received interface deleting message and the determined aggregation group ID from the match which is found in the aggregation group information table by the finding module according to the aggregation group ID determined by the determining module.

In addition, the finding module is further to look up a match in the local flow table according to the switch ID and the port ID carried in the interface deleting message after the receiving module 102 receives the interface deleting message.

The deleting module is further to delete the found match when the match is found in the local flow table by the finding module according to the switch ID and the port ID carried in the interface deleting message.

The sending module 105 is further to send a flow-modifying message to the SDN switch that is indicated by the switch ID carried in the interface deleting message when the match is found in the local flow table by the finding module according to the switch ID and the port ID carried in the interface deleting message, wherein the flow-modifying message carrying the switch ID and the port ID that are carried in the interface deleting message is used to instruct the corresponding SDN switch to look up a match in a local flow table according to the switch ID and the port ID and delete the found match.

According to another example of the present disclosure, the receiving module 102 is further to receive a downlink packet forwarded by the SDN switch, wherein the downlink packet is received by the SDN switch through an uplink interface connected with the physical switch.

The finding module 102 is further to find a corresponding port ID in an interface management table according to a destination MAC address and a VLAN ID of the downlink packet when the downlink packet received by the receiving module 102 is a unicast packet, wherein the interface management table records interface information corresponding to each VM, and the interface information includes a MAC address of a virtual network card interface on the VM connected with the SDN switch, a VLAN ID of the VLAN to which a dvport interface belongs, and a port ID of the dvport interface on the SDN switch connected with the VM.

The entry generating module 104 is further to generate a second flow table entry used for guiding forwarding of the downlink unicast packet according to the port ID found by the finding module and to store the second flow table entry in the local flow table, wherein an execute action of the second flow table entry includes that the downlink unicast packet is forwarded through the dvport interface indicated by the found port ID.

The sending module 105 is further to send the second flow table entry generated by the entry generating module 104 and the downlink unicast packet received by the receiving module to the SDN switch which sends the downlink unicast packet.

The finding module is further to find at least two corresponding port IDs in the interface management table according to a VLAN ID in a downlink packet when the downlink packet received by the receiving module 102 is a multicast packet, and to look up corresponding port ID in the interface management table according to a source MAC address and the VLAN ID in the multicast packet.

The entry generating module 104 is further to generate a third flow table entry according to the at least two port IDs when the corresponding ID is not found by the finding module and to store it in the local flow table, wherein an execute action of the third flow table entry includes that the downlink multicast packet is forwarded through the dvport interfaces indicated by the at least two port IDs. The entry generating module 104 is further to remove the port ID from the at least two port IDs when the corresponding port ID is found by the finding module, and to generate a fourth flow table entry according to rest of port IDs and store it in the local flow table, wherein an execute action of the fourth flow table entry includes that the downlink multicast packet is forwarded through the dvport interface(s) indicated by the rest of the port IDs.

The sending module 105 is further to send the flow table entry generated by the entry generating module 104 and the downlink multicast packet received by the receiving module to the SDN switch which sends the downlink multicast packet.

In the actual implementation process, as an example, in the distributed virtual switch system of the present disclosure, the functions of the creating and adding module and the aggregation processing module, and a part of the functions of the finding module, the receiving module and the deleting module are implemented by a LA management module. The functions of the entry generating module and the sending module, and the other part of the functions of the finding module, the receiving module and the deleting module are implemented by a flow management module.

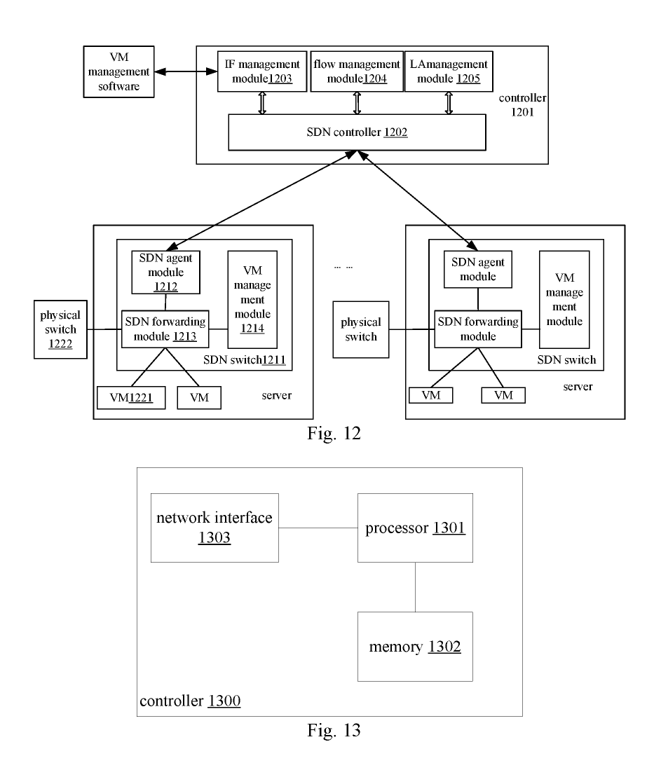

As shown in FIG. 12, the controller 1201 includes a SDN controller 1202, an IF (interface) management module 1203, a flow management module 1204 and a LA management module 1205. Take a server in the FIG. 12 as an example, a SDN switch 1211 in the server includes a SDN agent module 1212, a SDN forwarding module 1213 and a VM management module 1214. In one example the SDN switch is an OF switch including an OF agent module, OF forwarding module and a VM management module.

The SDN switch 1211 communicates with the controller 1201 through the SDN agent module 1212, sends data to the controller 1201 and or receives data from the controller 1201. The SDN forwarding module 1213 connected with VMs (a VM 1221 is taken as an example in the following description) and a physical switch 1222 in which stores a flow table is used to look up the table and forward a packet after receiving the packet sent by the VM 1221 or the physical switch 1222. The VM management module 1214 is used to manage and maintain the VMs. The controller 1201 communicates the SDN switch 1211 through the SDN controller 1202, sends data to the SDN switch 1211 and receives data from the SDN switch 1211; and the controller 1201 is used to store data, provide some services and support a link layer discovery protocol (LLDP). An interface management table is stored in the IF management module 1203 which is used to update and maintain the interface management table according to online/offline/migration of the VMs. An aggregation group information table is stored in the LA management module 1205 which is used to compute an outgoing interface for an uplink packet of a SDN switch. A flow table is stored in the flow management module 1204 which is used to generate an flow table entry and to delete an flow table entry.

1. The LA Management Module

(1) Increase of Member Ports

An aggregation management module (that is the LA management module 1205) is responsible for computation of the outgoing interface for the uplink packet that is transferred from a VM to a ToR. When the flow management module 1204 generates a first flow table entry used for guiding the forwarding of the uplink packet, the LA management module 1205 needs to compute the outgoing interface of the uplink packet.

A VMM Center binds the uplink interface of the SDN switch 1211 to an uplink port group, and sends a notice of the event to the SDN switch 1211, wherein the port ID of the uplink interface is included in the notice.

After receiving the notice, the SDN agent module 1212 in the SDN switch 1211 forwards the notice to the SDN forwarding module 1213. After receiving the notice, the SDN forwarding module 1213 generates an interface adding message and forwards it to the SDN agent module 1212. The interface adding message carrying the switch ID of the SDN switch 1211 and the port ID of the uplink interface is forwarded to the controller 1201 by the SDN agent module 1212.

After the SDN controller 1202 in the controller 1201 receive the interface adding message, the interface adding message is forwarded to the IF management module 1203 and then forwarded to the LA management module 1205 by the IF management module 1203.

The LA management module 1205 determines an aggregation group ID corresponding to the switch ID carried in the interface adding message, finds an entry having the determined aggregation group ID in the aggregation group information table, and adds a correspondence between the port ID carried in the interface adding message and the aggregation group ID to the entry having the determined aggregation group ID.

(2) Decrease of Member Ports

As an example, the VMM Center removes an uplink interface on the SDN switch 1211 from the uplink port group to which the uplink interface belongs, and sends a notice of the removing event to the SDN switch, wherein the port ID of the uplink interface is included in the notice. After the SDN agent module 1212 in the SDN switch 1211 receives the notice, the notice is forwarded to the SDN forwarding module 1213; and after the SDN forwarding module 1213 receives the notice, the SDN forwarding module 1213 generates an interface deleting message and sends it to the SDN agent module 1212, and then the interface deleting message is sent to the controller 1201 by the SDN agent module 1212. As another example, after the SDN forwarding module 1213 in the SDN switch 1211 detects that the state an uplink interface connected with the ToR is changed to DOWN state, an interface deleting message is generated and sent to the SDN agent module 1212, and then sent to the controller 1201 by the SDN agent module 1212, wherein the interface deleting message carries the switch ID of the SDN switch 1211 and the port ID of the uplink interface.

After the SDN controller 1202 in the controller 1201 receives the interface deleting message, the interface deleting message is forwarded to the IF management module 1203 and then forwarded to the LA management module 1205 and the flow management module 1204 by the IF management module 1203.

After receiving the interface deleting message, the LA management module 1205 determines an aggregation group ID corresponding to the switch ID carried in the interface deleting message, finds a match in the aggregation group information table according to the determined aggregation group ID, and deletes a correspondence between the port ID carried in the interface deleting message and the determined aggregation group ID from the found match.

After receiving the interface deleting message, the flow management module 1204 looks up a match in the local flow table according the switch ID and the port ID carried in the interface deleting message. When the match is found, the found match is deleted and a flow-modifying message is generated and forwarded to the SDN controller 1202, wherein the flow-modifying message carries the switch ID and the port ID which are carried in the interface deleting message, and is used to instruct the SDN switch 1211 to look up a match in the local flow table according to the switch ID and the port ID and delete the found match.

The SDN controller 1202 sends the flow-modifying message to the SDN switch 1211.

After receiving the flow-modifying message, the SDN agent module 1212 in the SDN switch 1211 forwards it to the SDN forwarding module 1213. After receiving the flow-modifying message, the SDN forwarding module 1213 looks up a match in the local flow table according to the switch ID and the port ID carried in the interface deleting message and deletes the found match.

2. The Flow Management Module

(1) Uplink Packet

After receiving an uplink packet form the VM 1221, the SDN forwarding module 1213 in the SDN switch 1211 looks up a match in the local flow table. When the match is not found, the packet is sent to the SDN agent module 1212 after being encapsulated as a SDN message, and then sent to the controller 1201 by the SDN agent module 1212, wherein a message header of the SDN message carries a switch ID and a source port ID of the SDN switch.

After receiving the SDN message, the SDN controller 1202 in the controller 1201 sends the SDN message to the flow management module 1204.

After receiving the SDN message, the flow management module 1204 obtains the uplink packet thereof through decapsulation. The corresponding VLAN ID is found according to the switch ID and the source port ID carried in the message header of the SDN message, and the switch ID and related information in a packet header of the uplink packet are sent to the LA management module 1205 at the same time. The LA management module 1205 determines a corresponding aggregation group according to the switch ID, selects an uplink interface of the aggregation group as an outgoing interface of the uplink packet by using the aggregation algorithm corresponding to the aggregation group according to the related information of the packet header of the uplink packet, and sends it to the flow management module 1204, wherein the related information includes one or more of: a source MAC address, a destination MAC address, a source IP address and a destination IP address.

The flow management module 1204 generates the first flow table entry guiding the forwarding of the uplink packet and stores it in the local flow table. The first flow table entry is forwarded to the SDN controller 1202 and then sent to the SDN switch 1211 by the SDN controller 1202, wherein the execute action of the generated flow table entry includes that the uplink packet to which the found VLAN ID is added is forwarded though the outgoing interface.

After receiving the uplink packet and the first flow table entry, the SDN agent module 1212 in the SDN switch 1211 forwards them to the SDN forwarding module 1213. The SDN forwarding module 1213 stores the first flow table entry in the local flow table, finds the first flow table entry in the local flow table according to the information in the packet header of the packet. The uplink packet is forwarded according to the execute action in the first flow table entry and sent to the ToR finally.

(2) Downlink Unicast Packet

After receiving the downlink unicast packet sent by the ToR, the SDN forwarding module 1213 in the SDN switch 1211 looks up a match in the local flow table. When the match is not found, the downlink unicast packet is forwarded to the SDN agent module 1212 after being encapsulated as the SDN message, and sent to the controller 1201 by the SDN agent module 1212.

After the SDN controller 1202 in the controller 1201 receives the SDN message, the SDN message is forwarded to the flow management module 1204.

After receiving the SDN message, the flow management module 1204 obtains the downlink unicast packet thereof through the decapsulation, and finds a corresponding port ID in the interface management table of the IF management module 1203 according to a destination MAC address and a VLAN ID of the downlink unicast packet, wherein the interface management table records interface information corresponding to each VM, and the interface information includes the switch ID of the SDN switch 1211 connected with the VM, a MAC address of a virtual network card interface on the VM connected with the SDN switch 1211, a VLAN ID of the VLAN to which a dvport interface belongs, and a port ID of the dvport interface on the SDN switch 1211 connected with the VM.

The flow management module 1204 generates a second flow table entry used for guiding the forwarding of the downlink unicast packet according to the found port ID and stores the second flow table entry in the local flow table. The generated second flow table entry and the downlink unicast packet are sent to the SDN controller 1202, and forwarded to the SDN switch 1211 by the SDN controller 1202, wherein an execute action of the second flow table entry includes that the downlink unicast packet is forwarded through the dvport interface indicated by the found port ID.

After receiving the downlink unicast packet and the second flow table entry, the SDN agent module 1212 in the SDN switch 1211 forwards them to the SDN forwarding module 1213. The SDN forwarding module 1213 stores the second flow table entry in the local flow table, finds the second flow table entry in the local flow table according to the information in the packet header of the packet. The downlink unicast packet is forwarded according to the execute action in the second flow table entry and sent to a destination VM finally.

(3) Downlink Multicast Packet

After receiving the downlink multicast packet sent by the ToR, the SDN forwarding module 1213 in the SDN switch 1211 looks up a match in the local flow table. When the match is not found, the downlink multicast packet is forwarded to the SDN agent module 1212 after being encapsulated as the SDN message, and sent to the controller 1201 by the SDN agent module 1212.

After the SDN controller 1202 in the controller 1201 receives the SDN message, the SDN message is forwarded to the flow management module 1204.

After receiving the SDN message, the flow management module 1204 obtains the downlink multicast packet thereof through the decapsulation, finds at least two corresponding port IDs in the interface management table of the IF management module 1203 according to a source MAC address and a VLAN ID of the downlink multicast packet, and looks up a corresponding port ID in the interface management table.

The flow management module 1204 generates a third flow table entry for guiding the forwarding of the downlink multicast packet according to the at least two port IDs when the corresponding ID is not found and stores it in the local flow table. The generated third flow table entry and the downlink multicast packet are sent to the SDN controller 1202, and sent to the SDN switch 1211 by the SDN controller 1202, wherein an execute action of the third flow table entry includes that the downlink multicast packet is forwarded through the dvport interfaces indicated by the at least two port IDs.

The flow management module 1204 removes the found port ID from the at least two port IDs when the corresponding port ID is found, and generates a fourth flow table entry for guiding the forwarding of the downlink multicast packet according to the rest of port IDs and store it in the local flow table. The generated fourth flow table entry and the downlink multicast packet are sent to the SDN controller 1202, and sent to the SDN switch 1211 by the SDN controller 1202, wherein an execute action of the fourth flow table entry includes that the downlink multicast packet is forwarded through the dvport interface(s) indicated by the rest of the port IDs.

After receiving the downlink multicast packet and the flow table entry, the SDN agent module 1212 in the SDN switch 1211 forwards them to the SDN forwarding module 1213. The SDN forwarding module 1213 stores the flow table entry in the local flow table, finds the flow table entry in the local flow table according to the information in the packet header of the packet. The downlink multicast packet is forwarded according to the execute action in the flow table entry and sent to at least one destination VM finally.

The above method for packet forwarding may be implemented by a controller 1300. As shown in FIG. 13, the controller 1300 usually includes a processor 1301, a memory 1302, and a network interface 1303, which are connected with each other by a bus. The memory 1302 is an example of a non-transitory machine readable storage medium. In some examples the memory 1302 may be RAM, ROM a hard drive etc. The processor 1301 may execute machine readable instructions stored in the non-transitory storage medium. In one example the processor 1301 may read software (i.e., machine-readable instructions) stored in the memory 1302, and may execute the software.

In conclusion, the examples of the present disclosure may achieve the following technical effects.

After the SDN switch is created, the controller will create the corresponding aggregation group corresponding to the SDN switch, and add multiple uplink interfaces on the SDN switch connected with the physical switch into the aggregation group. In such a case, after receiving the uplink packet that is sent by the SDN switch through the dvport interface, the controller may select an uplink interface of the aggregation group as the outgoing interface of the uplink packet by using the aggregation algorithm corresponding to the aggregation group according to the related information of the packet header of the uplink packet, and then generate the first flow table entry guiding the forwarding of the uplink packet according to the outgoing interface. The packet forwarding supporting the function of the link aggregation is implemented by the above method in the distributed virtual switch system based on the openflow. After the controller computes the outgoing interface for the first packet of a data flow by adopting the aggregation algorithm, generates the first flow table entry and sends it to the SDN switch, no aggregation algorithm is required to compute the outgoing interface for the subsequent packet of the data flow, thus improving the packet forwarding efficiency.

What is claimed is:

1. A method for packet forwarding, comprising:
receiving, by a controller of a virtual switch system, an uplink packet forwarded by a virtual SDN (Software Defined Networking) switch hosted on a server; said uplink packet originating from a virtual machine (VM) hosted on said server;
determining, by the controller, an outgoing interface from at least two uplink interfaces on the SDN switch respectively corresponding to aggregated member ports of a physical switch by using an aggregation algorithm according to the uplink packet; and
generating, by the controller, a first flow table entry, and sending the first flow table entry to the SDN switch, wherein the first flow table entry is to instruct the SDN switch to forward a received uplink packet to the physical switch through the outgoing interface.

2. The method according to claim 1, further comprising:
creating, by the controller, an aggregation group corresponding to the SDN switch before receiving the uplink packet, and adding the at least two uplink interfaces respectively corresponding to the aggregated member ports to the aggregation group; and
wherein determining, by the controller, the outgoing interface from at least two uplink interfaces on the SDN switch respectively corresponding to aggregated member ports of a physical switch by using an aggregation algorithm according to the uplink packet comprises:
determining, by the controller, the aggregation group corresponding to the SDN switch, and selecting the outgoing interface from the uplink interfaces in the aggregation group by using the aggregation algorithm corresponding to the aggregation group according to related information of a packet header of the uplink packet.

3. The method according to claim 2, wherein creating, by the controller, the aggregation group corresponding to the SDN switch, and adding the at least two uplink interfaces respectively corresponding to the aggregated member ports to the aggregation group comprises:
creating, by the controller, the aggregation group for the SDN switch, assigning an aggregation group identity (ID) to the aggregation group, and adding an entry to an aggregation group information table, wherein the entry comprising the aggregation group ID and the aggregation algorithm corresponding to the aggregation group;
receiving, by the controller, an interface adding message which is sent by the SDN switch after an uplink interface on the SDN switch connected with the physical switch is bound to an uplink port group, wherein the interface adding message carries a switch ID of the SDN switch and a port ID of the uplink interface;
determining, by the controller, the aggregation group ID corresponding to the switch ID carried in the interface adding message, and finding the entry having the aggregation group ID in the aggregation group information table; and
adding, by the controller, a correspondence between the port ID carried in the interface adding message and the aggregation group ID to the entry having the aggregation group ID.

4. The method according to claim 3, further comprising:
receiving, by the controller, an interface deleting message sent by the SDN switch, wherein the interface deleting message is sent by the SDN switch after the SDN switch removes its uplink interface from binding of the uplink port group or detects that its uplink interface become unavailable, and the interface deleting message carries the switch ID of the SDN switch and the port ID of the uplink interface;
determining, by the controller, the aggregation group ID corresponding to the switch ID carried in the interface deleting message, and finding a match in the aggregation group information table according to the aggregation group ID; and
deleting, by the controller, a correspondence between the port ID carried in the interface deleting message and the aggregation group ID from the match.

5. The method according to claim 4, further comprising:
looking up, by the controller, a match in a local flow table according to the switch ID and the port ID carried in the interface deleting message after receiving the interface deleting message; and
deleting, by the controller, the match when the match is found, and sending a flow-modifying message to the SDN switch that is indicated by the switch ID carried in the interface deleting message, wherein the flow-modifying message carrying the switch ID and the port ID is used to instruct the corresponding SDN switch to look up a match in a local flow table according to the switch ID and the port ID and to delete the found match.

6. The method according to claim 1, further comprising:
receiving, by the controller, a downlink packet forwarded by the SDN switch from the physical switch;
looking up, by the controller, a corresponding port ID in an interface management table according to a destination MAC address in the downlink packet when the downlink packet is a unicast packet, wherein the interface management table records interface information including a MAC address of a virtual network card interface on the VM connected with the SDN switch and a port ID of a downlink interface on the SDN switch connected with the VM; and
generating, by the controller, a second flow table entry according to the found port ID, and sending the second flow table entry to the SDN switch, wherein the second flow table entry is used to instruct the SDN switch to forward a received downlink unicast packet through a downlink interface indicated by the found port ID.

7. The method according to claim 6, further comprising:
finding, by the controller, at least two corresponding port IDs in the interface management table according to a VLAN ID in a downlink packet when the downlink packet is a multicast packet after receiving the downlink packet forwarded by the SDN switch;
looking up, by the controller, a corresponding ID in the interface management table according to a source MAC address in the multicast packet;
generating, by the controller, a third flow table entry according to the at least two port IDs, and sending the third flow table entry to the SDN switch when the corresponding ID is not found, wherein the third flow table entry is used to instruct the SDN switch to forward a received downlink multicast packet through downlink interfaces indicated by the at least two port IDs; and
removing, by the controller, the port ID from the at least two port IDs when the corresponding port ID is found, generating a fourth flow table entry according to rest of the port IDs, and sending the fourth flow table entry to the SDN switch, wherein the fourth flow table entry is used to instruct the SDN switch to forward a received downlink multicast packet through downlink interface(s) indicated by the rest of the port IDs.

8. A controller, comprising a processor and a non-transitory machine readable storage medium storing machine readable instructions that are executable by the processor to:
receive an uplink packet forwarded by a virtual SDN (Software Defined Networking) switch hosted on a server; said uplink packet originating from a VM (Virtual Machine) hosted on said server;
determine an outgoing interface from at least two uplink interfaces on the virtual SDN switch respectively corresponding to aggregated member ports of a physical switch by using an aggregation algorithm according to the uplink packet; and
generate a first flow table entry, and send the first flow table entry to the virtual SDN switch, wherein the first flow table entry is used to instruct the virtual SDN switch to forward a received uplink packet to the physical switch through the outgoing interface.

9. The controller according to claim 8, wherein the instructions are further to:
create an aggregation group corresponding to the SDN switch before receiving the uplink packet, and add the at least two uplink interfaces respectively corresponding to the aggregated member ports to the aggregation group; and
wherein determine the outgoing interface from at least two uplink interfaces on the SDN switch respectively corresponding to aggregated member ports of a physical switch by using an aggregation algorithm according to the uplink packet comprises:
determine the aggregation group corresponding to the SDN switch, and select the outgoing interface from the uplink interfaces in the aggregation group by using the aggregation algorithm corresponding to the aggregation group according to related information of a packet header of the uplink packet.

10. The controller according to claim 9, wherein the instructions are further to:
create the aggregation group for the SDN switch, assign an aggregation group identity (ID) to the aggregation group, and add an entry to an aggregation group information table, wherein the entry comprising the aggregation group ID and the aggregation algorithm corresponding to the aggregation group;
receive an interface adding message which is sent by the SDN switch after an uplink interface on the SDN switch connected with the physical switch is bound to an uplink port group, wherein the interface adding message carries a switch ID of the SDN switch and a port ID of the uplink interface;
determine the aggregation group ID corresponding to the switch ID carried in the interface adding message, and find the entry having the aggregation group ID in the aggregation group information table; and
add a correspondence between the port ID carried in the interface adding message and the aggregation group ID to the entry having the aggregation group ID.

11. The controller according to claim 10, wherein the instructions are further to:
receive an interface deleting message sent by the SDN switch, wherein the interface deleting message is sent by the SDN switch after the SDN switch removes its uplink interface from binding of the uplink port group or detects that its uplink interface become unavailable, and the interface deleting message carries the switch ID of the SDN switch and the port ID of the uplink interface;
determine the aggregation group ID corresponding to the switch ID carried in the interface deleting message, and find a match in the aggregation group information table according to the aggregation group ID; and
delete a correspondence between the port ID carried in the interface deleting message and the aggregation group ID from the match.

12. The controller according to claim 11, wherein the instructions are further to:
look up a match in a local flow table according to the switch ID and the port ID carried in the interface deleting message after receiving the interface deleting message; and
delete the match when the match is found, and send a flow-modifying message to the SDN switch that is indicated by the switch ID carried in the interface deleting message, wherein the flow-modifying message carrying the switch ID and the port ID is used to instruct the corresponding SDN switch to look up a match in a local flow table according to the switch ID and the port ID and delete the found match.

13. The controller according to claim 8, wherein the instructions are further to:
receive a downlink packet forwarded by the SDN switch from the physical switch;
look up a corresponding port ID in an interface management table according to a destination MAC address in the downlink packet when the downlink packet is a unicast packet, wherein the interface management table records interface information including a MAC address of a virtual network card interface on the VM connected with the SDN switch and a port ID of a downlink interface on the SDN switch connected with the VM; and
generate a second flow table entry according to the found port ID, and send the second flow table entry to the SDN switch, wherein the second flow table entry is used to instruct the SDN switch to forward a received downlink unicast packet through a downlink interface indicated by the found port ID.

14. The controller according to claim 13, wherein the instructions are further to:
find at least two corresponding port IDs in the interface management table according to a VLAN ID in a downlink packet when the downlink packet is a multicast packet after receiving the downlink packet forwarded by the SDN switch;
look up a corresponding ID in the interface management table according to a source MAC address in the multicast packet;
generate a third flow table entry according to the at least two port IDs, and send the third flow table entry to the SDN switch when the corresponding ID is not found, wherein the third flow table entry is used to instruct the SDN switch to forward a received downlink multicast packet through downlink interfaces indicated by the at least two port IDs; and
remove the port ID from the at least two port IDs when the corresponding port ID is found, generate a fourth flow table entry according to rest of port IDs, and send the fourth flow table entry to the SDN switch, wherein the fourth flow table entry is used to instruct the SDN switch to forward a received downlink multicast packet through downlink interface(s) indicated by the rest of port IDs.
